(19) United States
(12) Patent Application Publication
(10) Pub. No.: US 2013/0096851 A1
(43) Pub. Date: Apr. 18, 2013

(54) Filling level measurement device and method for determining a functional relationship between different tracks

(71) Applicant: VEGA Grieshaber KG, Wolfach (DE)

(72) Inventors: Christian HOFERER, Offenburg (DE); Roland WELLE, Hausach (DE)

(73) Assignee: VEGA Grieshaber KG, Wolfach (DE)

(21) Appl. No.: 13/651,668

(22) Filed: Oct. 15, 2012

Related U.S. Application Data
(60) Provisional application No. 61/547,863, filed on Oct. 17, 2011.

(30) Foreign Application Priority Data
Oct. 17, 2011 (DE) 11 185 454.3

(51) Int. Cl. G01F 23/00; G06F 19/00

(52) U.S. Cl. 702/55

(57) ABSTRACT

The parameters are calculated of a target function which describes the relationship of the positions of two different tracks. Using this target function, the position of another track can then be derived from the position of one track.

### REFERENCE TO RELATED APPLICATIONS

This application claims the benefit of the filing date of European Patent Application No. EP 11 185 454.3 filed 17 Oct. 2011, the disclosure of which is hereby incorporated herein by reference and of U.S. Provisional Patent Application No. 61/547,863 filed 17 Oct. 2011, the disclosure of which is hereby incorporated by reference.

### FIELD OF THE INVENTION

The invention relates to the technical field of filling level measurement. In particular, the invention relates to a filling level measuring device for calculating a functional relationship between two tracks for determining a filling level, a method for calculating such a functional relationship for determining a filling level, a program element and a computer-readable medium.

### TECHNICAL BACKGROUND

The present invention relates to a method for determining the position of a filling material surface in the measurement of filling levels of all types.

In filling level sensors which operate in accordance with FMCW or pulsed transit time methods, electromagnetic or acoustic waves are transmitted in the direction of a filling material surface. Subsequently, a sensor records the echo signals reflected by the filling material, the container fixtures and the container itself and derives therefrom the location or position of a surface of at least one of the filling materials in the container.

When using acoustic or optical waves, the signal produced by the filling level measuring device generally propagates freely in the direction of the filling material surface to be measured. In devices which use radar waves to measure the filling material surface, both free propagation in the direction of the medium to be measured and propagation inside a hollow conductor which guides the radar waves from the filling level measuring device to the medium may be considered. In devices in accordance with the principle of guided microwaves, the high-frequency signals are guided along a waveguide to the medium. At the surface of the medium or filling material to be measured, a portion of the incoming signals is reflected and, after a corresponding transit time, returns to the filling level measuring device. The non-reflected signal portions enter the medium and propagate in accordance with the physical properties of the medium therein further in the direction of the container base. These signals are also reflected at the container base and, after passing through the medium and the superimposed atmosphere, return to the filling level measuring device.

The filling level measuring device receives the signals reflected at various locations and determines therefrom the distance to the filling material.

The determined distance to the filling material is provided externally. It may be provided in analogue form (4-20 mA interface) or in digital form (field bus).

It is common to all methods that the signal used for measurement when travelling from the filling level measuring device to the filling material surface is generally located in the range of influence of another medium which is to be referred to below as a “superimposed medium”. This superimposed medium is located between the filling level measuring device and the surface of the medium to be measured and is generally constituted by a fluid or a gaseous atmosphere.

In the majority of applications, air is located above the medium to be measured. Since the propagation of electromagnetic waves in air differs only insubstantially from that in a vacuum, no particular corrections are required for the signals that are reflected back by the filling material, the container fixtures and the container itself through the air to the filling level measuring device.

However, in process containers from the chemical industry, all types of chemical gases and gas mixtures may further occur as a superimposed medium. Depending on the physical properties of these gases or gas mixtures, the propagation properties of electromagnetic waves are changed in comparison with a propagation in a vacuum or in air.

The following explanations concentrate on the consideration of the frequently occurring application of a single medium or filling material to be measured in a container. The relationships set out below may be transferred to the application of two different media or filling materials in one container. The position of a filling material surface may be in connection with a partition layer measurement, in particular also the position of a partition layer between two different media or filling materials, which is identical to the position of the filling material surface of the lower of the two filling materials or media in a container for partition layer measurement.

Methods are known in which a precise classification of the echo to be measured is necessary in order to determine the filling level.

### SUMMARY OF THE INVENTION

According to a first aspect of the invention, a filling level measuring device is specified which has an echo curve detection unit for detecting a plurality of temporally successive echo curves. Furthermore, the filling level measuring device has an evaluation unit which can determine a first echo and (at least) a second echo in each of the echo curves detected, respectively, by evaluating the echo curves.

In this instance, the first echo is associated with any first track and the second echo with any second track of the echo curves. The term “track” in this instance refers to a series of position values which is calculated from the positions of the associated echoes. Furthermore, the evaluation unit is configured to calculate a first functional relationship between the positions of the first track and the positions of the second track of the echo curves.

The echo curve detection unit further serves to detect an additional, temporally subsequent echo curve, whereupon the evaluation unit determines the position of a first echo of the additional echo curve by evaluating the additional echo curve, the first echo being associated with the first track. Furthermore, the evaluation unit is configured to subsequently calculate the position of the second track of the additional echo curve using the position of the first echo of the additional echo curve, or the position of the first track of the additional echo curve, and the first functional relationship.

It should be noted in this instance that the track does not directly have to be a component part of the echo curve. A track may also be evaluated and continued within a separate function. The wording that the track belongs to the echo curve means that the track and the echo curve are consistent with each other. This may mean that an echo which was found in the echo curve has already been associated with the track. Furthermore, this may mean that, if no echo of the echo curve can be associated with the track, the track position has nonetheless been updated.

The updating differs depending on the method used. If no echo of the additional echo curve is associated with the track, the position of the track of the first echo curve can be used as a new position of the track of the additional echo curve. Furthermore, the position of the track of the additional echo curve can be calculated from the previous path of the track and the temporal spacing between the first and the additional echo curve. Furthermore, it may be the case that a track, when no echo of the additional echo curve has been associated therewith, takes over only the time stamp of the additional echo curve (this may be the scanning time of the echo curve). This track may also then be referred to as a track of the additional echo curve.

In other words, therefore, two tracks can be compared with each other in each case so that a functional relationship between the individual positions of the one track and the corresponding positions of the other track can be calculated. This functional relationship between the positions of the two tracks is then used to determine the position of the second track from the position of the first track.

A functional relationship is thus determined between two tracks in each case. In this instance, the position of the one track at a specific time may be identical to the corresponding position of the echo which belongs to this track, for example, the last echo added. However, this is only one embodiment of the tracking algorithm used. There are other methods which calculate the position of a track, for example, from the weighted mean of a plurality of reflections or from the mean between a prediction and measurements (tracking using a Kalman filter). In this instance, the position of the last echo received sometimes does not correspond exactly to the current position of the track.

The position of the first echo determined in the new echo curve may consequently be the position of the first track at this time. However, the position of the first track may be determined not only with reference to the additional echo curve (that is, the newly determined first echo), but additionally using other items of information, for example, by using a filter.

The filling level measuring device operates according to a transit time method, for example according to the FMCW method or the impulse-transit time method.

The transmission unit of the filling level measuring device transmits a transmission signal, for example in form of a transmission impulse or a frequency-modulated wave, in the direction of the filling level material surface. The transmission signal is completely or partly reflected by various reflectors (such as the filling level surface, the bottom of the container and stationary discontinuities in the container, for example). The reflected transmission signal is detected by the echo curve detection unit in form of an echo curve which may comprise a plurality of single echoes (i.e. the filling level echo, the container bottom echo, one or more stationary discontinuity echo, . . . respectively).

The evaluation unit of the filling level measuring device may now perform a tracking method, in which an echo of each echo curve of a chronological series of echo curves is assigned to a particular echo group and in which the temporal development of the positions of the echoes is represented in form of a track.

Any two tracks (for example the track of the container bottom echo and the track of the filling level surface echo) may now be brought into a functional relationship with respect to each other, by approximating the timely development of the first track by a mathematically described curve and by approximating the timely development of the second track by another mathematically described curve. The two mathematic approximations or functions may now be compared to each other in a mathematical manner, thus resulting in the mathematical, functional relationship between the two tracks. The functional relationship is a mathematical function which is an approximation. In the simplest case it is a linear equation. It may also be a more complex function, depending on how the mathematical descriptions of the first track and the second track look like.

If a further echo curve is detected the expected position of the second track at the time the further echo curve has been detected can be calculated by using the functional relationship and the position of the other track at this time (or the position of the echo at this time which is assigned to this track).

According to another aspect of the invention, the functional relationship is a linear relationship which is calculated from the individual track positions.

According to another aspect of the invention, the evaluation unit is further configured to determine the position of each third echo in each of the detected echo curves by evaluating the echo curves, the third echoes being associated with any third track. Subsequently, a calculation of a second functional relationship between the positions of the second track and the positions of the third track of the echo curves can be carried out. Subsequently, the position of a third echo of the additional echo curve is determined by means of evaluation of the additional echo curve, the third echo belonging to the third track. Afterwards, the position of the second track of the additional echo curve is calculated using the position of the third echo of the additional echo curve or the position of the third track and the second functional relationship.

According to another aspect of the invention, the evaluation unit is further configured to average the calculated positions of the second echoes of the additional echo curve.

According to another aspect of the invention, the evaluation unit is further configured to average the calculated positions of the second track of the additional echo curve.

According to another aspect of the invention, a plausibility control operation of the calculated positions of the second echo of the additional echo curve can be carried out. This can be carried out after a classification of the corresponding tracks.

According to another aspect of the invention, the evaluation unit is further configured to calculate the position of the second track of the additional echo curve using the functional relationships between all N(N−1)/2 pairs of the N tracks of the echo curves, N being a positive whole number.

According to another aspect of the invention, the evaluation unit is further configured to calculate the position of the second track of the additional echo curve using only the functional relationships between N−1 pairs of the N tracks of the echo curves, N being a positive whole number.

According to another aspect of the invention, the first echoes are multiple echoes which can be attributed to multiple reflections.

According to another aspect of the invention, the first echoes are multiple echoes of the filling material surface and the second echoes are single echoes of the filling material surface, that is to say, the actual filling level echoes.

A multiple echo is an echo which is attributed to multiple reflection of the transmission signal at the same reflection location (for example, the filling material surface, a partition face between two media of the filling material, a container fixture or the container base). A base echo is an echo which is attributed to a reflection of the transmission signal on the container base of the filling material container. Furthermore, a multiple echo may be a reflected signal which has been reflected at least once on a cover face before it was received.

According to another aspect of the invention, a method is specified for determining a filling level in which a plurality of temporally successive echo curves are detected. Subsequently, a first echo and a second echo are determined in each of the detected echo curves, respectively, by evaluating the echo curves, the first echoes being associated with any first track and the second echoes being associated with any second track of the echo curves. Afterwards, a first functional relationship between the positions of the first track and the positions of the second track of the echo curves is calculated. Furthermore (beforehand or afterwards), an additional, temporally subsequent echo curve is detected, whereupon the position of a first echo of the additional echo curve is determined by evaluating the additional echo curve, the first echo belonging to the first track. Subsequently, the position of a second track of the additional echo curve is calculated using the position of the first echo of the additional echo curve, or the position of the first track, and the first functional relationship.

According to another aspect of the invention, a program element is specified which, when it is carried out on a processor of a filling level measuring device, instructs the filling level measuring device to carry out the method steps described above and below.

According to another aspect of the invention, a computer-readable medium is specified on which a program element is stored and which, when it is carried out on a processor of a filling level measuring device, instructs the filling level measuring device to carry out the method steps described above and below.

Embodiments of the invention are described below with reference to the figures.

### BRIEF DESCRIPTION OF THE FIGURES

FIG. 1 shows a radar filling level measuring device having a container according to an embodiment of the invention,

FIG. 2 shows echo curves,

FIG. 3 is a block diagram of a signal processing operation according to an embodiment of the invention,

FIG. 4 is a graphical illustration of the relationship of track positions according to an embodiment of the invention,

FIG. 5 shows the path of two tracks,

FIG. 6 is a graphical illustration of the relationship of track positions of two tracks according to an embodiment of the invention,

FIG. 7 shows a method for reducing the combinatorics in the filling level determination according to an embodiment of the invention.

### DETAILED DESCRIPTION OF EMBODIMENTS

The illustrations in the figures are schematic and not drawn to scale. If the same reference numerals are used in different figures, they may refer to elements which are identical or similar. However, elements which are identical or similar may also have different reference numerals.

Various methods, according to which the position of a filling material surface in a container can be detected, can be used during the filling level measurement.

FIG. 1 shows an arrangement for filling level measurement. The container 109 is filled to a filling level d_{B}−d_{L} with a fluid 106. The space 107 above the fluid is filled, for example, with air. In the present example, the fluid is covered with air as a superimposed medium.

The filling level measuring device 101 produces an electromagnetic pulse 103 with the aid of a high-frequency unit 102 and couples it into a suitable antenna 104, whereupon this pulse propagates substantially at the speed of light in the direction towards the filling material surface 105 to be measured. The exact speed within the superimposed medium is calculated as follows:

$${c}_{L} = \frac{{c}_{0}}{\sqrt{{ɛ}_{L} \cdot {μ}_{L}}}$$

where cₒ describes the light speed in the vacuum, ε_{L} the permittivity value of the superimposed medium and μ_{L} the permeability value of the superimposed medium.

The filling material surface 105 reflects a portion of the incoming signal energy, whereupon the reflected signal portion is propagated back to the filling level measuring device 101. The non-reflected signal portion enters the fluid 106 and propagates therein with greatly reduced speed in the direction towards the container base. The speed c_{M} of the electromagnetic wave 103 within the fluid 106 is determined by the material properties of the fluid 106:

$${c}_{M} = \frac{{c}_{0}}{\sqrt{{ɛ}_{M} \cdot {μ}_{M}}}$$

where cₒ describes the light speed in the vacuum, ε_{M} the permittivity value of the fluid and μ_{M} the permeability value of the fluid. At the base 108 of the container 109, the remaining signal portion is also reflected and reaches the filling level measuring device 101 again after a corresponding transit time. In the filling level measuring device, the incoming signals are prepared using the high-frequency unit 102 and transformed, for example, into a lower-frequency intermediate frequency range. Using an analogue/digital convertor unit 110, the analogue echo curves which are provided by the high-frequency unit 102 are digitised and made available to an evaluation unit 111.

The above-mentioned components which are used to provide a digitised echo curve, that is to say, in particular the high-frequency unit 102 and the analogue/digital convertor unit 110, may define an echo curve detection device by way of example.

The evaluation unit 111 analyses the digitised echo curve and determines, on the basis of the echoes contained therein in accordance with known methods, the echo that was produced by the reflection at the filling material surface 105. In addition, the evaluation unit 111 which may also act in the present example as a measurement device determines the exact electrical distance to this echo. Furthermore, the determined electrical distance to the echo can be corrected in such a manner that influences of the superimposed medium 107 on the propagation of the electromagnetic waves are compensated for. The distance to the filling material calculated and compensated for in this manner is transmitted to an output unit 112 which further prepares the value determined in accordance with the provisions of the user, for example, by means of linearisation, offset correction, conversion to a filling level d_{B}−d_{L}. The measured value prepared is provided externally to an external communication interface 113. In this instance, all established interfaces can be used, in particular 4-20 mA current interfaces, industrial field buses such as HART, Profibus, FF, but also computer interfaces such as RS232, RS485, USB, Ethernet or FireWire.

The processor 121 controls the evaluation unit 111 and may of course be part of the evaluation unit. Furthermore, a storage element (computer-readable medium 122) is provided on which a program element for controlling the processor is stored.

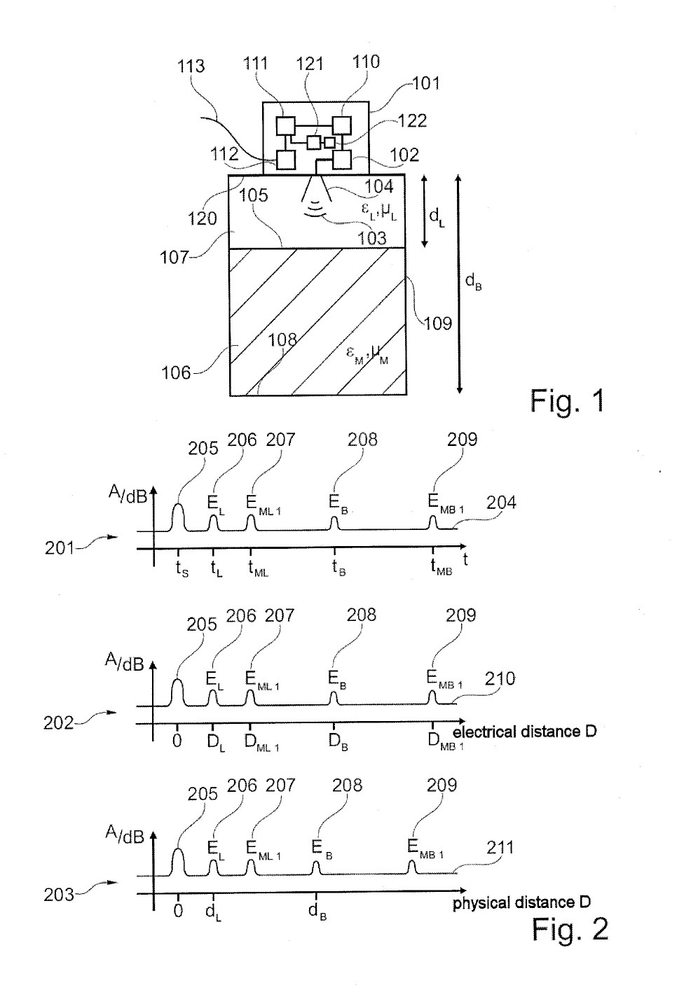

FIG. 2 again sets out in detail important steps which are used in the context of the echo signal processing in the evaluation unit 111 for compensation for the influences of various media.

The curve path 201 first shows the echo curve 204 detected by the analogue/digital convertor unit 110 over time. The echo curve first contains the portion of the transmission pulse 205 reflected inside the antenna. A short time afterwards, at the time t_{L}, a first echo 206 is detected which is caused by the reflection of signal portions at the boundary 105 or the surface 105 of the medium 106 in the container. Another echo 207 is produced as a first multiple echo of the filling material echo 206 and is detected at the time t_{ML}. The signal portions which enter the medium 106 are reflected on the container base 108 after passing through the filling material 106 and produce another echo 208 inside the echo curve 204. This base echo 208 is detected at the time t_{B}. Furthermore, at the time t_{MB}, a multiple echo 209 of the base echo may be detected.

In a first processing step, the time-dependent curve 201 is transformed into a distance-dependent curve 202. During this transformation, it is assumed that the detected curve has been exclusively formed by a propagation in the vacuum. The ordinate of the illustration 201 is converted by means of multiplication with the speed of light in the vacuum into a distance axis. Furthermore, by means of calculation of an offset, the echo 205 caused by the antenna 104 receives the distance value Om. Furthermore, the distance values are multiplied by the factor 0.5 in order to eliminate the dual path to the filling material surface and back.

The second illustration 202 shows the echo curve as a function of the electrical distance D. The electrical distance corresponds to half of the distance which an electromagnetic wave travels in the vacuum within a specific time. The electrical distance does not take into account any influences of a medium which may lead to a slower propagation of the electromagnetic waves. The curve path 202 therefore constitutes an echo curve which is not compensated but which is localised.

In the present description, electrical distances are always designated with upper case letters D, whilst physical distances which can be measured directly at the container are designated with lower case letters d.

It may further be possible to fully compensate the echo curve 210. The third illustration 203 shows a fully-compensated echo curve 211. In order to achieve an illustration of the echoes over the physical distance, in the present case the influence of the superimposed medium 107 in the region between the locations 0 and D_{L} (curve path 202) must be taken into account. The electrical distance indications of the abscissa must be converted between 0 and D_{L} into physical distance indications in accordance with the following relationship:

$${d}_{i} = \frac{{D}_{i}}{\sqrt{{ɛ}_{L} \cdot {μ}_{L}}}$$

Since ε_{Luft} and μ_{Luft} substantially correspond to the value 1, no correction has to be carried out for this portion in the present example. The electrical distance indications of the abscissa greater than or equal to D_{L} must, however, be converted into physical distance indications in accordance with the following relationship:

$${d}_{i} = {d}_{L} + \frac{( {D}_{i} - {D}_{L} )}{\sqrt{{ɛ}_{M} \cdot {μ}_{M}}}$$

Finally, the third illustration 203 shows the corrected path. Both the distance to the echo 206 of the filling material surface 105 and the distance to the echo 208 produced by the container base 108 correspond to the distances which can be measured on the container 109. The distance to the multiple echo 207 of the filling material surface cannot be measured directly on the container since the above compensation is valid only for direct reflections. The same applies to the multiple echo 209 of the reflection at the container base 108.

It should be noted at this point that the conversion into a curve path 202, that is to say, the determination of the electrical distances or the position of various echoes is carried out in the context of the signal processing in the filling level measuring device, for example, for all echoes. The conversion of the echo curves into a compensated echo curve is generally not carried out, but the correction of a single distance value or the position of an echo is sufficient.

Problems may occur with the filling level measuring device described above in that not only are the reflected signal portions received by the filling material surface, but also undesirable reflections occur, which are caused by so-called interference locations in the container. An interference location in the container may be caused, for example, by fixtures or the container geometry itself. In addition to the interference locations, so-called repeated or multiple reflections may further be superimposed on the useful signal in such a manner that both the identification of the useful signals from the filling material surface and the exact measurement of the useful signals are greatly impaired.

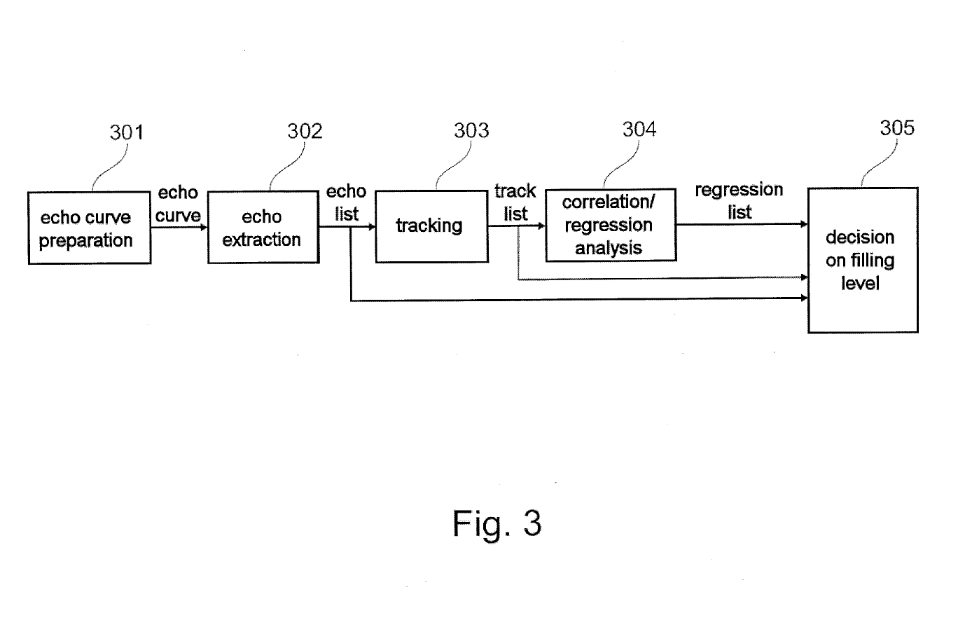

A possible embodiment of the evaluation device 111 of a filling level measuring device is illustrated in greater detail in FIG. 3 as a block diagram. The echo curve may first be subjected to a preparation operation 301. Owing to a selective digital revaluation of the signal, for example, by means of digital filtering, it is more readily possible for a method for echo extraction 302 to determine the significant signal portions from the echo curve.

The extracted echoes may be stored for further processing, for example in the form of a list. However, there are also possibilities for access to the data other than storage in a list. The function block tracking 303 associates the echoes of an echo curve at the time tᵢ with the echoes of the subsequent echo curve at the time tᵢ₊₁, the echoes having passed through the same physical reflection location and the same path.

Tracking methods are already prior art and known to the person skilled in the art. Further information can be found, for example, in WO 2009/037000 A2. The method according to an embodiment of the invention is referred to in the block diagram as a correlation/regression analysis 304. A core aspect of the invention is to place the positions of two tracks, that is to say, the positions of two different physical reflection locations or two reflections which have travelled different paths, in relation to each other and to establish the parameters of a linear relationship therefrom. Each track comprises a series of position values which have been established from the echoes of an echo curve. Since, in filling level measurement devices, the spacing from the sensor to the filling material is intended to be measured, the term “distance” is also used in addition to the term “position”.

In the embodiment of FIG. 3, the echo, track and regression lists are transferred to the function block “decision on filling level” (305). This function block establishes, inter alia, the echo which is produced by the indirect reflection at the filling material surface and classifies it as a filling level echo.

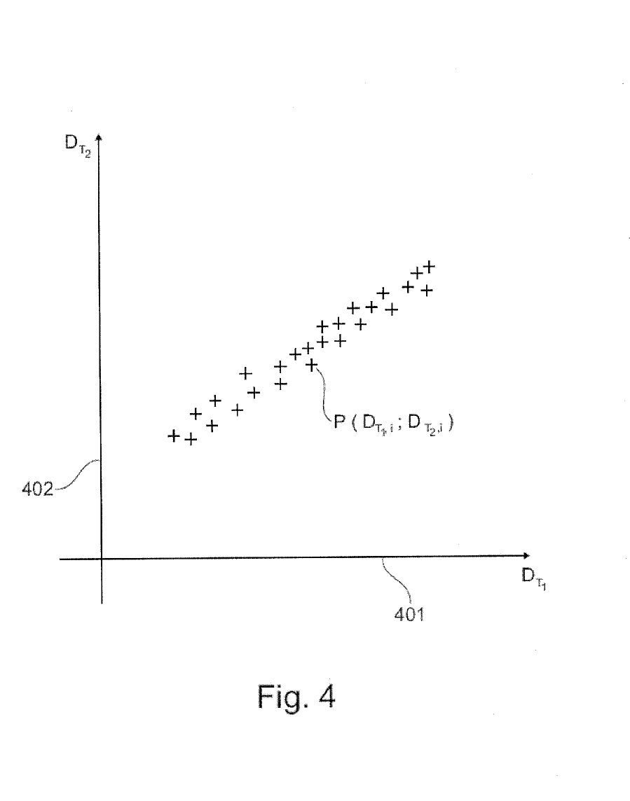

FIG. 4 is intended to explain in greater detail the facts of the relationship between two tracks. The system of coordinates shows a scatter plot which is formed from the distance pairs of the individual position values of two tracks. For example, the tracks are referred to as track T₁ and track T₂. However, any other conceivable combination of two different tracks can be used.

Each distance pair is indicated with a cross. The abscissa axis (x axis 401) comprises the distance D of the track T₁, the ordinate axis (y axis 402) comprises the distance D of the track T₂. This arrangement is not absolutely necessary. The abscissa axis and the ordinate axis could thus also be interchanged. The measurement unit of the axis scaling is also irrelevant for the invention. The electrical distance D is thus purely exemplary here. A temporal scaling of the position according to the echo curve 204 would also be possible. A distance pair is indicated separately in FIG. 4 for further explanation. The distance pair P(D_{T}_{ₐ}_{,i}; D_{T}_{₂}_{,i}) describes a value pair of two positions of track T₁ and track T₂ at the time i, at which the echo curve was produced. The other points in the graph not set out in greater detail originate from other echo curves which were detected by the sensor at other times. A new echo curve produced by the sensor which originates from another signal processing operation and whose echoes were associated with the tracks would expand the graph by an additional point. The relationship of the positions of the two tracks illustrated in FIG. 4 makes it clear that the positions of track T₁ and track T₂ can be related. This means that track T₁ and track T₂ are in a functional relationship. A straight line equation which describes the scatter plots serves as a basis for this. Mathematically, this relationship can be described as follows:

D_{T}_{₂}_{,k}=a₁·D_{T}_{₁}_{,k}+a₀+eₖ (4.1)

### Where:

D_{T}_{₂}_{,k} is the position of the track T₂ of the measurement at time k
D_{T}_{₁}_{,k} is the position of the track T₁ of the measurement at time k
a₀ and a₁ are the parameters of a straight line, which describe the linear relationship between the position of track T₁ and track T₂.
eₖ is the error of the relationship for the measurement at time k

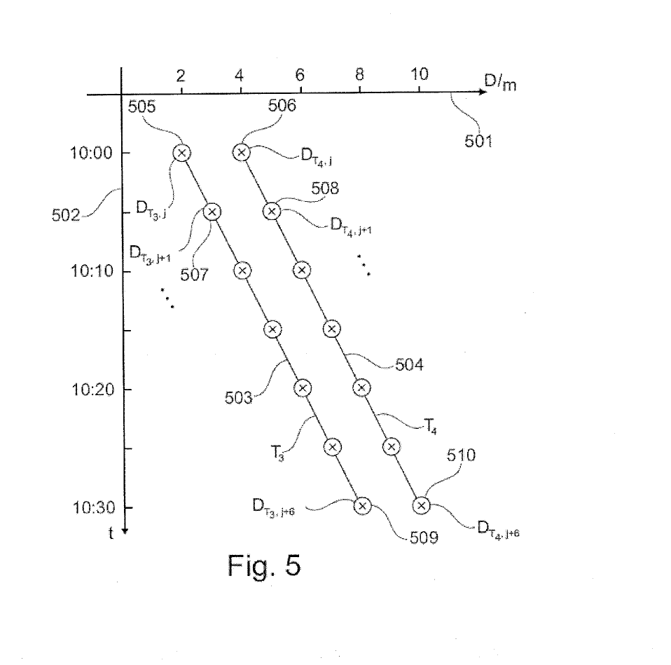

The parameter a₁ of the function has no measurement unit, whereas a₀ has the same measurement unit as D_{T}_{₂}_{,k} or D_{T}_{₁}_{,k}. eₖ carries the same measurement unit as D_{T}_{₂}_{,k} or D_{T}_{₁}_{,k}. Postulating an error in the given relationship is necessary since the errors of the model are thus illustrated in a summarised manner. The parameters a₁ and a₀ are dependent on the given properties of the measuring location at which the sensor is used. In addition, the parameters are dependent on the path of the tracks, which are brought into correlation with each other. Formula (4.1) is only a characteristic of the relationship. Naturally, it can be used on any track and does not necessarily require track T₁ and track T₂ as a basis. However, the values of the parameters a₁ and a₀ are then different from the relationship between track T₁ and track T₂. FIG. 5 shows the exemplary path of two tracks (T₃ 503 and T₄ 504) over time.

The x axis 501 refers to the distance in meters and the y axis 502 refers to the measuring time t. The support locations 505, 507, 509, . . . and 506, 508, 510, . . . of the tracks 503, 504, which are produced from the echo positions of the echo curves at the relevant time j are each marked by an x.

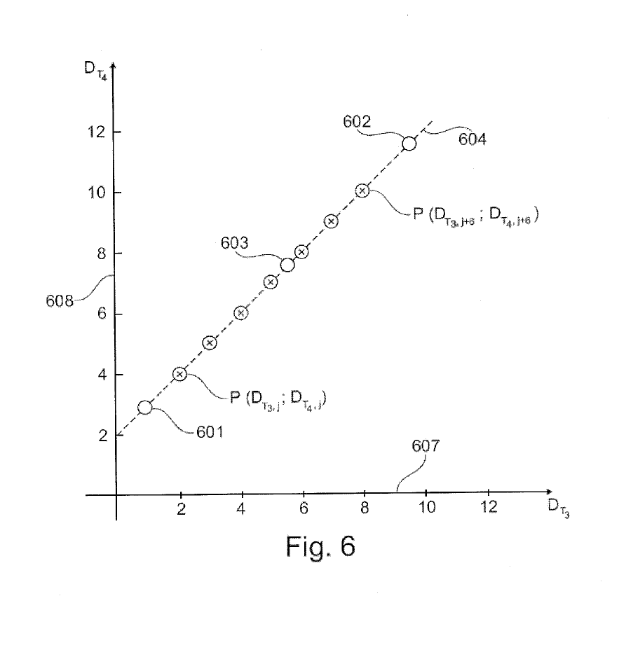

If the support locations from FIG. 5 are transferred into a graph, which clarifies the relationship between the two tracks in the same manner as FIG. 4, the graph in FIG. 6 is produced. The x axis 607 in this instance comprises the positions of track T₃, the y axis 608 comprises in this instance the positions of track T₄. In addition, the linear relationship 604 between the two tracks is indicated in the form of a broken line. It should now be noted that, in addition to the support locations in FIG. 6, other statements relating to the relationship of both tracks can be made. Both for positions 603, which are located between the support locations and for positions 602 and 601 which are located beside the support locations, the relationship can be used. Furthermore, this means that, when the position of one track is known, the position of the other track can be predicted. This prediction can be reversed. In the example from FIG. 6, this means that the position of track T₄ can be predicted from the position of track T₃ and vice versa. Furthermore, not only can a prediction be made, but also an estimation of the position of a track can be given when it would not be possible to determine the position of the track owing to unfavourable signal relationships.

Determination of the parameters a₀ and a₁:

The parameters a₀ and a₁ may be determined independently from the function block correlation/regression analysis 304. Owing to the error in the model which is used as a basis, a so-called estimation of the parameters is advantageous, which minimises the error relating to the determination of the parameters. The estimation itself may be carried out in different manners. It is possible to use conventional parameter estimation methods, such as, for example, an LS estimator. LS estimators are described in detail in literature, for example, in Kiencke, Eger “Messtechnik—Systemtheorie für Elektrotechniker” (“Measurement technology—System Theory for Electrical Engineers) ISBN 3-540-24310-0 or Bronstein, Semendjajew, Musiol, Mühling “Taschenbuch der Mathematik” (“Pocketbook of Mathematics”) ISBN 3-8171-2006-0. A determination of the compensation or regression straight lines in accordance with Lothar Papula “Mathematik für Ingenieure and Naturwissenschaftler Band 3” (“Mathematics for Engineers and Natural Scientists Volume 3”) ISBN 3-528-24937-4 is also possible. An estimation may be configured thus, for example:

D_{T}_{₂}=â₁·D_{T}_{₁}+â₀
D_{T}_{₂} is the position of the track T₂
D_{T}_{₁} is the position of the track T₁
â₀ and â₁ are the estimated parameters of a straight line, which describe the linear relationship between the position of track T₁ and track T₂.

In order not to have to retain the position pairs continuously in the memory, the mentioned methods may also be implemented in a recursive manner. The estimation may be incorrect at first but improves as the number of pairs of values increases. It is naturally necessary to first establish the parameters before a prediction of the current position of the one track can be made from the position of the other track.

The invention described can advantageously be expanded. The echo curve often shows a large number of echoes, which involves many tracks. In the method described, all tracks are generally placed in relation to each other. This means that, from each individual track, a statement can be made directly about the location of any other track. The number A of the functional relationships to be established can be calculated in accordance with the number N of tracks with the formula

A=N·(N−1)/2

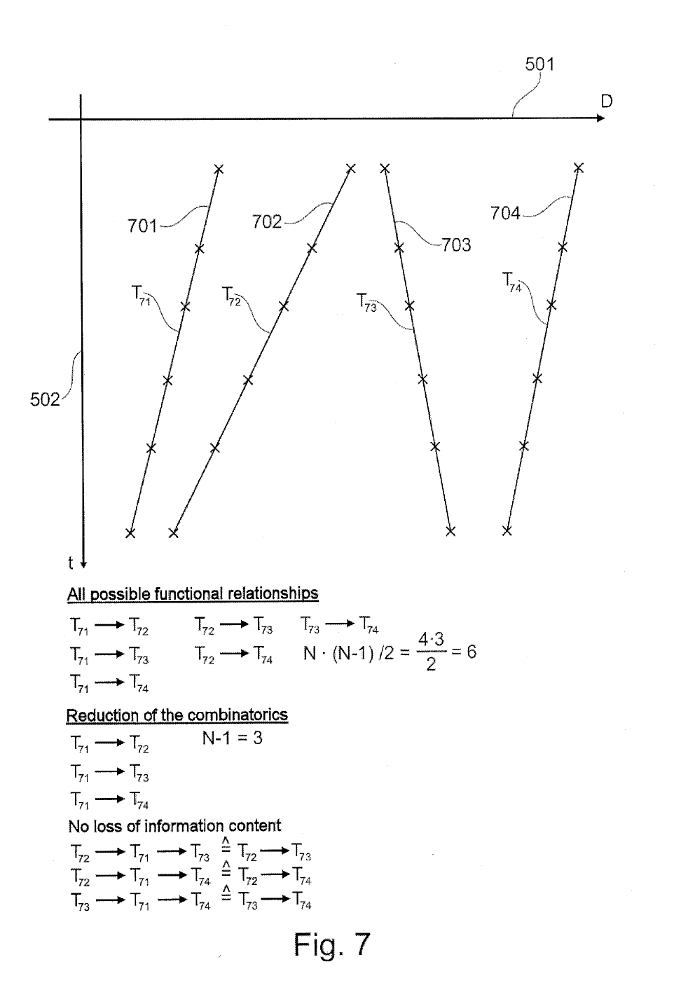

With four monitored tracks, six relationships must then be produced, calculated, maintained and stored. An expansion of the invention is achieved by means of selective reduction of the combinatorics. FIG. 7 illustrates the complete listing with four different tracks. The functional relationships are indicated with an arrow. The direction of the arrow is merely exemplary, since the relationship can also be reversed. If, for example, the relationship T₇₁→T₇₂ is known, the relationship T₇₂→T₇₁ can also be calculated by forming the inverse function. Furthermore, FIG. 7 illustrates a possibility for reducing the combinatorics without reducing the significance of the invention. For example, the reduction was carried out with reference to the track T₇₁. The relationships between T₇₂ and T₇₃, T₇₂ and T₇₄ or T₇₃ and T₇₄ can be calculated from the relationships T₇₁ and T₇₂, T₇₁ and T₇₃ or T₇₁ and T₇₄. It is then only necessary to store and expand

A=N−1

(in FIG. 7 then three) functional relationships. The reduction requires that a track have to be selected as the origin of the reduction. This track could also be referred to as an intermediate track. In the example from FIG. 7, this is track T₇₁. Of course, any other track could also be selected as the intermediate track of the reduction. The calculation chain from FIG. 7 shows that no information content is lost. For example, the relationship between T₇₂→T₇₃ can be established from the two relationships T₇₁→T₇₂ and T₇₁→T₇₃. To this end, the inverse function T₇₁←T₇₂ must be formed by T₇₁→T₇₂. Subsequently, the expanded relationship T₇₂→T⁷¹→T₇₃ can be established and the location of track T₇₃ can be determined from track T₇₂ without having previously estimated the parameters of the functional expression for the relationship T₇₂→T₇₃. In this instance, there are advantages in terms of performance since the estimation of the parameters involves intensive calculations. Furthermore, storage space is saved. A core aspect of the expansion is thus that the combinatorics can be reduced if, when calculating the position of a track T_{A} from the position of a track T_{B}, the calculation is always carried out via an intermediate track T_{C}.

A core aspect of the method described involves estimating the parameters of a target function, which then describes the relationship of the position between two tracks. If the parameters of the target function were established sufficiently well during the operation of the filling level measuring device, the position of another track can be derived from the position of one track. Since the parameters are dependent on the measurement location (installation location, connector, flange, container base, container lid, filling material, fixtures in the container), a parameterisation in the factory cannot be carried out.

In addition, it should be noted that the terms “comprising” and “having” do not exclude any other elements or steps and “a” or “an” does not exclude a plurality. It should further be noted that features or steps which have been described with reference to one of the above embodiments can also be used in combination with other features or steps of other embodiments described above. Reference numerals in the claims are not intended to be regarded as limitations.

1. A filling level measuring device, comprising:
an echo curve detection unit detecting a plurality of temporally successive echo curves; and
an evaluation unit configured to:
determine a first echo and a second echo in each of the echo curves detected, respectively, by evaluating the echo curves, the first echoes being assigned to a first track and the second echoes being assigned to a second track;
calculate a first functional relationship between the positions of the first track and the positions of the second track of the echo curves;
the echo curve detection unit being configured to detect an additional echo curve;
the evaluation unit being further configured to:
determine the position of a first echo of the additional echo curve by evaluating the additional echo curve, the first echo belonging to the first track;
calculate the position of the second track at the time of the additional echo curve using the position of the first echo of the additional echo curve, or the position of the first track at the time of the additional echo curve, and the first functional relationship.

2. The filling level measuring device according to claim 1, wherein the first functional relationship is a linear relationship.

3. The filling level measuring device according to claim 1, wherein the evaluation unit is further configured to:
determine the positions of each third echo in each of the detected echo curves, respectively, by evaluating the echo curves, the third echoes being assigned to a third track;
calculate a second functional relationship between the positions of the second track and the positions of the third track of the echo curves;
determine the position of a third echo of the additional echo curve by evaluating the additional echo curves, the third echo belonging to the third track;
calculating the position of the second track at the time of the additional echo curve using the position of the third echo of the additional echo curve, or the position of the third track at the time of the additional echo curve, and the second functional relationship.

4. The filling level measuring device according to claim 3, wherein the evaluation unit is further configured to:
average the calculated positions of the second track at the time of the additional echo curve.

5. The filling level measuring device according to claim 1, wherein the evaluation unit is further configured to:
carry out a plausibility control operation of the calculated position of the second track at the time of the additional echo curve.

6. The filling level measuring device according to claim 1, wherein the evaluation unit is further configured to:
calculate the position of the second track at the time of the additional echo curve using the functional relationships between all N(N−1)/2 pairs of the N tracks of the echo curves, N being a positive whole number.

7. The filling level measuring device according to claim 1, wherein the evaluation unit is further configured to:
calculate the position of the second track at the time of the additional echo curve using only the functional relationships between N−1 pairs of the N tracks of the echo curves, N being a positive whole number.

8. The filling level measuring device according to claim 1, wherein the first echoes are multiple echoes which are attributed to multiple reflections.

9. The filling level measuring device according to claim 1, wherein the first echoes are multiple echoes of the filling material surface; and
the second echoes are single echoes of the filling material surface.

10. A method for determining a filling level, comprising the steps of:
detecting a plurality of temporally successive echo curves;
determining a first echo and a second echo in each of the echo curves detected, respectively, by evaluating the echo curves, the first echoes being assigned to a first track and the second echoes being assigned to a second track;
calculating a first functional relationship between the positions of the first track and the positions of the second track of the echo curves;
detecting an additional echo curve;
determining the position of a first echo of the additional echo curve by evaluating the additional echo curve, the first echo belonging to the first track;
calculating the position of the second track at the time of the additional echo curve using the position of the first echo of the additional echo curve, or the position of the first track at the time of the additional echo curve, and the first functional relationship.

11. A non-transitory program element which, when it is carried out on a processor of a filling level measuring device, instructs the filling level measuring device to carry out the steps according to claim 10.

12. A computer-readable medium on which a program element according to claim 11 is stored.
